(19) United States
(12) Patent Application Publication
(10) Pub. No.: US 2010/0079894 A1
(43) Pub. Date: Apr. 1, 2010

(54) MAGNETIC TRANSFER MASTER CARRIER AND MAGNETIC TRANSFER METHOD USING THE SAME

(75) Inventors: Yoichi Nishida, Odawara-shi (JP); Masakazu Nishikawa, Odawara-shi (JP); Hideyuki Kubota, Odawara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/570,342

(22) Filed: Sep. 30, 2009

(30) Foreign Application Priority Data
Sep. 30, 2008 (JP) 2008-255721
Sep. 25, 2009 (JP) 2009-221252

(51) Int. Cl. G11B 5/02; G11B 5/17

(52) U.S. Cl. 360/55; 360/123.06; G9B/5.026; G9B/5.05

(57) ABSTRACT

To provide a magnetic transfer master carrier to be placed on a perpendicular magnetic recording medium so as to transfer magnetic information to the medium by application of a magnetic field, the magnetic transfer master carrier including: transfer portions that include a magnetic layer and correspond to the magnetic information; and non-transfer portions which are lower in height than the transfer portions that include the magnetic layer, and each of which has a concave shape, wherein the magnetic layer has perpendicular magnetic anisotropy, and the magnetic anisotropy energy of the magnetic layer is less than 4×10⁶ erg/cm³.

Corresponding to Japanese Patent Application No. 2008-255721 filed on Sep. 30, 2008 and Japanese Patent Application No. 2009-221252 filed on Sep. 25, 2009 the entirety of which applications are hereby expressly incorporated by reference in the accompanying application.

### BACKGROUND OF THE INVENTION

1. Field of the Invention

The present invention relates to a magnetic transfer master carrier for transferring magnetic information to a perpendicular magnetic recording medium, and a magnetic transfer method using the magnetic transfer master carrier.

2. Description of the Related Art

As magnetic recording media capable of recording information in a highly dense manner, perpendicular magnetic recording media are well known. An information recording area of a perpendicular magnetic recording medium is composed of narrow tracks. Thus, a tracking servo technique for accurate scanning with a magnetic head within a narrow track width and for reproducing a signal with a high S/N ratio is important for the perpendicular magnetic recording medium. To perform this tracking servo, it is necessary to record servo information, for example a servo signal for tracking, an address information signal, a reproduction clock signal, etc. as a so-called preformat at predetermined intervals on the perpendicular magnetic recording medium.

As a method for preformatting servo information on a perpendicular magnetic recording medium, there is, for example, a method wherein while a master carrier with a pattern including a magnetic layer, which corresponds to the servo information, is closely attached to the magnetic recording medium, a recording magnetic field (transfer magnetic field) is applied to the magnetic recording medium and the master carrier so as to magnetically transfer the pattern of the master carrier to the magnetic recording medium (refer to Japanese Patent Application Laid-Open (JP-A) Nos. 2003-203325 and 2000-195048 and U.S. Pat. No. 7,218,465B1, for example).

In this method, when the transfer magnetic field is applied to the magnetic recording medium and the master carrier with these closely attached to each other, a magnetic flux is absorbed into the magnetic layer on the pattern based upon the magnetized state of the master carrier, and the magnetic field is strengthened correspondingly to the concavo-convex shape of the pattern. By this magnetic field strengthened in the form of the pattern, only predetermined places on the magnetic recording medium are magnetized. Accordingly, magnetic materials with high saturation magnetization have hitherto been frequently used as materials for master magnetic layers (magnetic layers of master carriers).

Parenthetically, the magnetic layer of the master carrier is roughly several tens of nanometers in thickness and is therefore very thin. For that reason, once a transfer magnetic field is applied, a strong demagnetizing field is generated in the magnetic layer. When the demagnetizing field becomes strong, an effective magnetic field applied to the magnetic layer decreases even if a magnetic material with high saturation magnetization is used, and thus the concavo-convex magnetic layer comes into an unsaturated state. Hitherto, attempts have been made to bring the magnetic layer into a near-saturated state by further increasing an externally applied magnetic field to secure transfer magnetic field strength and increasing an effective magnetic field applied to the magnetic layer. However, since the magnetic layer magnetization increase rate related to the increasing of the applied magnetic field is in proportion to the strength of the applied magnetic field, the above-mentioned situation is, in effect, tantamount to a situation where a strong magnetic field is applied to a material with low saturation magnetization. The transfer magnetic field becomes strong on convex portions, causing the perpendicular magnetic recording medium to be magnetized in an almost saturated manner; however, the transfer magnetic field becomes strong on concave portions as well. Thus, the difference in transfer magnetic field strength between the convex portions and the concave portions is small. When servo information is transferred to the magnetic recording medium, with the difference in transfer magnetic field strength between the convex portions and the concave portions being small, a reversal of magnetization arises at places (concave portions) that should not be magnetized, so that the quality of the recording signal degrades, which is a problem.

In order to reduce the occurrence of the problem, the master carrier's magnetic layer itself needs to be magnetized in a saturated manner at a desired transfer magnetic field strength at least when the transfer magnetic field is applied, thereby enabling the magnetization value to be large.

When the magnetization value of the master carrier's magnetic layer itself can be sufficiently increased by a transfer magnetic field having a minimum strength required to magnetize the magnetic recording medium, the difference in transfer magnetic field strength between the convex portions and the concave portions can be increased, which is particularly favorable.

Under such circumstances, as the material of the magnetic layer, use of a material having magnetic anisotropy which acts in a direction perpendicular to the surface of the magnetic layer is being examined. It is thought that if such a material having perpendicular magnetic anisotropy is used for the magnetic layer of the master carrier, it is possible to minimize the strength of a transfer magnetic field applied as well as to easily increase the magnetization value of the magnetic layer by the transfer magnetic field.

However, regarding a conventional magnetic transfer method employing a magnetic transfer master carrier in which a material having perpendicular magnetic anisotropy is used as a magnetic layer, when convex portions of the magnetic transfer master carrier and a slave disk are in contact with each other after removal of an external magnetic field subsequent to magnetic transfer, a remanent magnetization of the magnetic transfer master carrier possibly generates a magnetic field which weakens a transfer signal, thus disturbing the transfer signal at portions where the convex portions and the slave disk are in contact with each other.

FIGS. 11A to 11C each show a magnetized state of a magnetic transfer master carrier before, during or after magnetic transfer. In FIGS. 11A to 11C, first of all, when an external magnetic field Hd is applied to a magnetic transfer master carrier 111 in an initial state, i.e. unmagnetized state (see FIG. 11A), a magnetic layer 112 is magnetized (FIG. 11B). Thereafter, when the external magnetic field Hd is removed, the magnetic layer 112 gets out of the magnetized state in the case where it is made of a material not having magnetic anisotropy, whereas the magnetic layer 112 gets into a magnetized state with stabilized energy as shown in FIG. 11C in the case where it is made of a material having magnetic anisotropy. As to the magnetized state of the magnetic transfer master carrier 111 in the latter case, it is magnetized not only in the same direction as that of the external magnetic field Hd but also in the opposite direction to that of the external magnetic field Hd, so that when a slave disk 110 is in close contact with the magnetic transfer master carrier 111 in this magnetized state, a transfer signal may be disturbed at portions of the slave disk 110 in contact with the magnetic layer 112 (see FIG. 11C).

### BRIEF SUMMARY OF THE INVENTION

The present invention is aimed at solving the problems in related art and achieving the following object. An object of the present invention is to provide a magnetic transfer master carrier capable of performing excellent magnetic recording without a transfer signal being disturbed by remanent magnetization, and a magnetic transfer method using the magnetic transfer master carrier.

Means for solving the problems are as follows.

<1> A magnetic transfer master carrier to be placed on a perpendicular magnetic recording medium so as to transfer magnetic information to the medium by application of a magnetic field, the magnetic transfer master carrier including: transfer portions that include a magnetic layer and correspond to the magnetic information; and non-transfer portions which are lower in height than the transfer portions that include the magnetic layer, and each of which has a concave shape, wherein the magnetic layer has perpendicular magnetic anisotropy, and the magnetic anisotropy energy of the magnetic layer is less than 4×10⁶ erg/cm³.
<2> The magnetic transfer master carrier according to <1>, wherein the magnetic anisotropy energy of the magnetic layer is in the range of 6×10⁵ erg/cm³ to 3×10⁶ erg/cm³.
<3> The magnetic transfer master carrier according to <2>, wherein the magnetic anisotropy energy of the magnetic layer is in the range of 9×10⁵ erg/cm³ to 2×10⁶ erg/cm³.
<4> The magnetic transfer master carrier according to any one of <1> to <3>, wherein the magnetic layer has a thickness of less than 50 nm.
<5> The magnetic transfer master carrier according to <4>, wherein the magnetic layer has a thickness of 10 nm to 40 nm.
<6> The magnetic transfer master carrier according to <5>, wherein the magnetic layer has a thickness of 20 nm to 40 nm.
<7> The magnetic transfer master carrier according to any one of <1> to <6>, wherein the magnetic layer has a saturation magnetization (Ms) of 600 emu/cc or above.
<8> A magnetic transfer method including: initially magnetizing a perpendicular magnetic recording medium in a perpendicular direction; closely attaching the magnetic transfer master carrier according to any one of <1> to <7> to the initially magnetized perpendicular magnetic recording medium; and transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other.

According to the present invention, it is possible to solve the problems in related art and achieve the object of providing a magnetic transfer master carrier capable of performing excellent magnetic recording without a transfer signal being disturbed by remanent magnetization, and a magnetic transfer method using the magnetic transfer master carrier.

### BRIEF DESCRIPTION OF THE DRAWINGS

FIG. 1A is a drawing for explaining a step in a perpendicular magnetic recording transfer method (Part 1).

FIG. 1B is a drawing for explaining a step in the perpendicular magnetic recording transfer method (Part 2).

FIG. 1C is a drawing for explaining a step in the perpendicular magnetic recording transfer method (Part 3).

FIG. 2A is a partially cross-sectional view showing a master disk according to an embodiment (Part 1).

FIG. 2B is a partially cross-sectional view showing a master disk according to another embodiment (Part 2).

FIG. 3A is a drawing for explaining a method for producing a master disk, according to an embodiment (Part 1).

FIG. 3B is a drawing for explaining the method for producing a master disk, according to the embodiment (Part 2).

FIG. 3C is a drawing for explaining the method for producing a master disk, according to the embodiment (Part 3).

FIG. 3D is a drawing for explaining the method for producing a master disk, according to the embodiment (Part 4).

FIG. 3E is a drawing for explaining the method for producing a master disk, according to the embodiment (Part 5).

FIG. 4F is a drawing for explaining the method for producing a master disk, according to the embodiment (Part 6).

FIG. 4G is a drawing for explaining the method for producing a master disk, according to the embodiment (Part 7).

FIG. 4H is a drawing for explaining the method for producing a master disk, according to the embodiment (Part 8).

FIG. 4I is a drawing for explaining the method for producing a master disk, according to the embodiment (Part 9).

FIG. 4J is a drawing for explaining the method for producing a master disk, according to the embodiment (Part 10).

FIG. 5 is a top view of a master disk.

FIG. 6 is a drawing for explaining a cross section of a slave disk.

FIG. 7 is a drawing for explaining the magnetization direction of a magnetic layer (recording layer) after an initially magnetizing step.

FIG. 8 is a drawing for explaining a magnetic transfer step.

FIG. 9 is a schematic structural drawing of a magnetic transfer apparatus used in the magnetic transfer step.

FIG. 10 is a drawing for explaining the magnetization direction of the magnetic layer (recording layer) after the magnetic transfer step.

FIG. 11A is a drawing showing a conventional magnetic transfer method (Part 1).

FIG. 11B is a drawing showing the conventional magnetic transfer method (Part 2).

FIG. 11C is a drawing showing the conventional magnetic transfer method (Part 3).

### DETAILED DESCRIPTION OF THE INVENTION

The following explains a magnetic transfer master carrier according to an embodiment of the present invention.

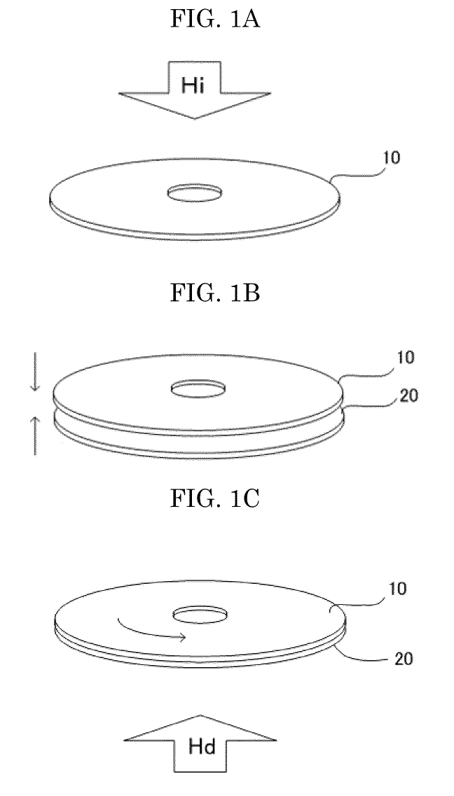

First of all, an outline of a magnetic transfer technique for perpendicular magnetic recording will be explained with reference to FIGS. 1A to 1C. FIGS. 1A to 1C are drawings for explaining respective steps in a magnetic transfer method for perpendicular magnetic recording. In FIGS. 1A to 1C, the numeral 10 denotes a slave disk (which is equivalent to a perpendicular magnetic recording medium) as a magnetic disk to which magnetic information is to be transferred, and the numeral 20 denotes a master disk as a magnetic transfer master carrier.

As shown in FIG. 1A, a DC magnetic field (Hi) is applied to a surface of the slave disk 10 from a perpendicular direction so as to initially magnetize the slave disk 10 (initially magnetizing step).

After the initially magnetizing step, the initially magnetized slave disk 10 and the master disk 20 are closely attached to each other as shown in FIG. 1B (closely attaching step).

After these disks 10 and 20 have been closely attached to each other, a magnetic field (Hd), which acts in the opposite direction to the direction of the magnetic field (Hi) applied at the time of the initial magnetization, is applied to the disks as shown in FIG. 1C, such that the magnetic information which the master disk 20 has is transferred to the slave disk 10 (magnetic transfer step).

The magnetic transfer master carrier of the present embodiment is equivalent to the master disk 20 shown in FIGS. 1A to 1C. The following explains the master carrier of the present embodiment, referring to this master disk 20 as an example.

### (Magnetic Transfer Master Carrier (Master Disk))

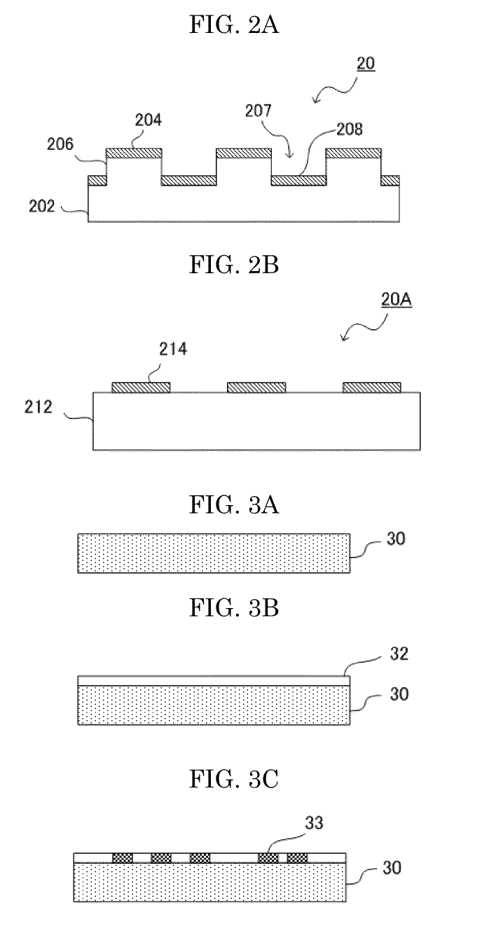

FIG. 2A is a partially cross-sectional view showing the master disk (master carrier) 20. This master disk 20 includes a base material 202 and a magnetic layer 204 formed on the surface of the base material 202. The base material 202 is provided with convex portions 206 and concave portions 207 on its surface. The convex portions 206 are provided with the magnetic layer 204 on their surfaces. Additionally, in the present embodiment, a magnetic layer 208 is formed on the surfaces of the concave portions 207 for the sake of facilitation of production, etc. In other embodiments, however, the provision of the magnetic layer 208 in the concave portions 207 may be omitted.

The convex portions 206 of the base material 202 and the magnetic layer 204 formed at the surfaces (apical surfaces) of the convex portions 206 serve as bit portions corresponding to transfer signal(s). These bit portions are equivalent to transfer portions that include portions to reverse an initial magnetization. Meanwhile, the concave portions 207 are equivalent to non-transfer portions where a magnetization is not reversed.

FIG. 2B is a partially cross-sectional view showing a master disk 20A according to another embodiment. This master disk 20A includes a base material 212 and, on the surface of the base material 212, a magnetic layer 214 serving as bit portions corresponding to transfer signal(s). As to this master disk 20A, the magnetic layer 214 is equivalent to transfer portions, and portions (gaps) between adjacent sections of the magnetic layer 214 are equivalent to non-transfer portions.

### <Base Material>

The base material is produced using a known material, for example glass, a synthetic resin such as a polycarbonate, a metal such as nickel or aluminum, silicon, carbon, etc.

### <Magnetic Layer>

The magnetic layer has perpendicular magnetic anisotropy, and the magnetic anisotropy energy (Ku) of the magnetic layer is less than 4×10⁶ erg/cm³. The magnetic anisotropy energy (Ku) can be measured using a known magnetic anisotropy torquemeter.

The expression “has perpendicular magnetic anisotropy” means that the ratio (Mpe/Min) of the magnetization value (Mpe) of a perpendicular magnetization curve to the magnetization value (Min) of an in-plane magnetization curve, which can be calculated in accordance with the following method, is 1 or above in relation to a hysteresis curve subjected to a demagnetizing field correction. Min and Mpe are calculated as follows.

Using a known vibrating sample magnetometer, magnetic fields are applied in an in-plane direction and a perpendicular direction to a magnetic layer which is the same as the magnetic layer of the magnetic transfer master carrier so as to measure the magnetization curves.

The magnetization value (Mpe) of the perpendicular magnetization curve and the magnetization value (Min) of the in-plane magnetization curve at the strength of an externally applied magnetic field equal to the strength of a recording magnetic field are calculated based upon the magnetization curves obtained.

The magnetic anisotropy energy of the magnetic layer is less than 4×10⁶ erg/cm³, preferably in the range of 6×10⁵ erg/cm³ to 3×10⁶ erg/cm³, and more preferably in the range of 9×10⁵ erg/cm³ to 2×10⁶ erg/cm³. When the magnetic anisotropy energy is too small, it is difficult to perpendicularly orient the magnetic layer.

Also, the thickness of the magnetic layer is preferably less than 50 nm, more preferably in the range of 10 nm to 40 nm, and even more preferably in the range of 20 nm to 40 nm. When the magnetic layer is too thick, a transfer signal is greatly disturbed by remanent magnetization. When the magnetic layer is too thin, it is impossible to perform magnetic transfer with a high signal output.

The saturation magnetization (Ms) of the magnetic layer is preferably 600 emu/cc or above. When the saturation magnetization is less than 600 emu/cc, it is possible that even when the magnetic layer has perpendicular magnetic anisotropy and is magnetized in a saturated manner, a sufficient difference in transfer magnetic field strength between convex portions and concave portions may not be secured and thus adequate transfer properties may not be secured. In other words, the difference between the strength of a magnetic field generated from the convex portions of the magnetic transfer master carrier and the strength of a magnetic field generated from the concave portions of the magnetic transfer master carrier can be further increased by increasing the saturation magnetization (Ms) of the magnetic layer.

Also, the nucleation magnetic field (Hn) of the magnetic layer is preferably a positive value (Hn>0). When the nucleation magnetic field (Hn) is 0 or less (Hn≦0), a great magnetic field is generated from the magnetic layer even after removal of a transfer magnetic field subsequent to the finish of magnetic transfer, so that overwriting may arise, making it impossible to record a desired signal.

The nucleation magnetic field (Hn) of the magnetic layer is preferably lower than or equal to the applied magnetic field (transfer magnetic field, Hd) in strength because the saturation magnetization (Ms) of the magnetic layer can be effectively utilized.

The saturation magnetization (emu/cc) and the nucleation magnetic field (Hn) of the magnetic layer can be calculated using a known vibrating sample magnetometer. The saturation magnetization (emu/cc) can be calculated by measuring the saturation magnetic moment (emu) from a magnetization curve obtained using the vibrating sample magnetometer, and dividing the saturation magnetic moment by the volume (cc) of the magnetic layer. The nucleation magnetic field (Hn) can be calculated from the magnetization curve.

The value of the remanent magnetization (Mr) of the magnetic layer is preferably small. When it is greater than a certain value, a magnetic field is generated from the master disk even after the transfer magnetic field has stopped being applied, so that when the master disk is separated from a slave disk, unnecessary transfer may occur, which leads to signal noise. The remanent magnetization (Mr) of the magnetic layer is preferably equivalent to 80% or less of the value of the saturation magnetization; specifically, it is preferably 480 emu/cc or less.

When the value of the coercive force (Hc) of the magnetic layer is too large, the magnetic layer is not magnetized by the applied magnetic field. When a transfer magnetic field with great strength is applied, the magnetic field in the concave portions is strengthened. Therefore, the coercive force (Hc) of the magnetic layer is preferably weaker than or equal to the coercive force of a corresponding perpendicular magnetic recording medium; specifically, it is preferably 6,000 Oe or less, more preferably 4,000 Oe or less.

The material used for the magnetic layer of the master disk (master carrier) is an alloy or compound composed of at least one ferromagnetic metal selected from Fe, Co and Ni and at least one nonmagnetic substance selected from Cr, Pt, Ru, Pd, Si, Ti, B, Ta and O. It is particularly desirable that the material be an alloy (CoCr) composed of Co and Cr, or an alloy (CoPt) composed of Co and Pt.

A protective layer is formed over the surface of the master disk to improve the mechanical properties, friction resistance and weatherability of the master disk. As the material for this protective layer, a hard carbon film is preferable; for example, inorganic carbon, diamond-like carbon, etc. formed by sputtering may be used. Further, a layer formed of a lubricant (a lubricant layer) may be formed over this hard protective layer.

A fluorine resin, e.g. perfluoropolyether (PFPE), is generally used as such a lubricant.

The magnetic layer of the master disk (master carrier) can be formed by sputtering, for example. In the case where the magnetic layer is formed of CoPt, for example, its magnetic properties can be controlled primarily by adjusting the sputter pressure and the Pt concentration at the time of formation of the magnetic layer. Note that when the sputter pressure is set at lower than 0.2 Pa, electric discharge is generally difficult. The sputter pressure is preferably 0.2 Pa to 50 Pa, more preferably 0.2 Pa to 10 Pa. The Pt concentration is preferably 5 at. % to 30 at. %, more preferably 10 at. % to 20 at. %.

### <Underlying Layer>

In order to adjust the perpendicular orientation, magnetic anisotropy energy (Ku), saturation magnetization (Ms) and nucleation magnetic field (Hn) of the magnetic layer of the master disk (master carrier), an underlying layer may be formed under the magnetic layer (between the magnetic layer and the base material). The formation of the underlying layer under the magnetic layer makes it easier to perpendicularly orient the magnetic layer.

The material for the underlying layer is, for example, a metal, alloy or compound that contains at least one selected from the group consisting of Pt, Ru, Pd, Co, Cr, Ni, W, Ta, Al, P, Si and Ti. The material for the underlying layer is preferably a platinum group metal such as Pt or Ru, a metal such as Ta, or an alloy thereof. The underlying layer may have a single-layer structure or a multilayer structure.

The thickness of the underlying layer is preferably 1 nm to 30 nm, and more preferably 5 nm to 20 nm. When the thickness of the underlying layer is greater than 30 nm, the shape of the magnetic layer formed on the pattern of the master disk may degrade, thereby possibly leading to degradation of the distribution of a transfer magnetic field and degradation of the quality of a recording signal. When the thickness of the underlying layer is less than 1 nm, the magnetic layer may not be able to be perpendicularly oriented, or the magnetic anisotropy energy, saturation magnetization and nucleation magnetic field of the magnetic layer may not be able to be controlled.

The thickness of the underlying layer is preferably 20 nm or less. When the thickness is 20 nm or less, it is possible to reduce degradation of the shape of the pattern after the formation of the magnetic layer and greatly improve magnetic transfer properties.

### <Method for Producing Master Disk>

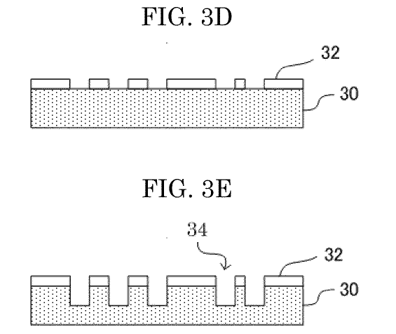

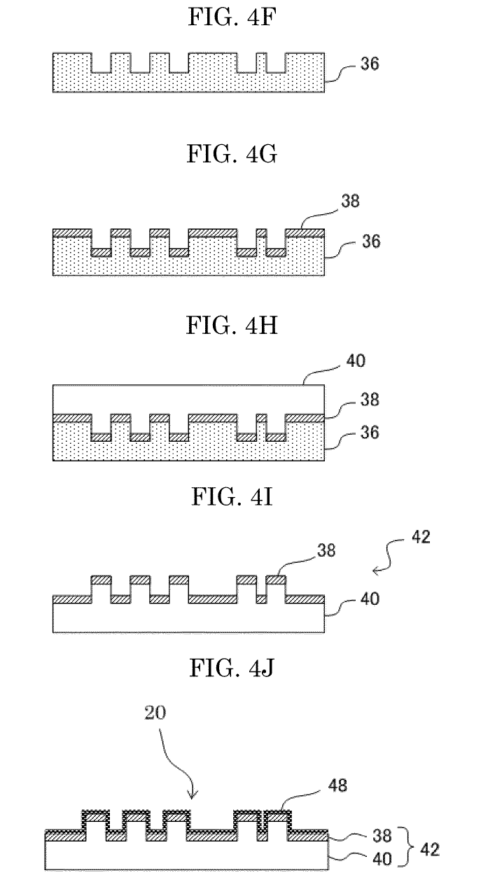

FIGS. 3A to 3E and FIGS. 4F to 4J are drawings for explaining a process of producing a master disk. A method for producing a master disk according to an embodiment will be explained with reference to FIGS. 3A to 3E and FIGS. 4F to 4J.

As shown in FIG. 3A, an original plate (Si substrate) 30, which is a silicon wafer whose surface is smooth, is prepared, an electron beam resist solution is applied onto this original plate 30 by spin coating or the like so as to form a resist layer 32 thereon (see FIG. 3B), and the resist layer 32 is baked (pre-baked).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 3C).

Subsequently, as shown in FIG. 3D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (post-baking) is carried out to enhance the adhesion between the resist layer 32 and the original plate 30.

Subsequently, as shown in FIG. 3E, parts of the original plate 30 are removed (etched) at places where opening portions 34 of the resist layer 32 exist, such that hollows having a predetermined depth are formed in the original plate 30. As to this etching, anisotropic etching is desirable in that an undercut (side etching) can be minimized. Reactive ion etching (RIE) can be suitably employed as such anisotropic etching.

Thereafter, as shown in FIG. 4F, the resist layer 32 is removed. Regarding the method for removing the resist layer 32, ashing can be employed as a dry method, and a removal method using a release liquid can be employed as a wet method. By the ashing process, an original master 36 on which an inversion of a desired concavo-convex pattern is formed is produced.

Subsequently, as shown in FIG. 4G, a conductive layer 38 is formed on the surface of the original master 36 so as to have a uniform thickness. The method for forming this conductive layer 38 can be suitably selected from metal deposition methods and the like, including PVD (physical vapor deposition), CVD (chemical vapor deposition), sputtering and ion plating. Formation of one layer made of a conductive film (denoted by the numeral 38), as described above, makes it possible to obtain such an effect that a metal can be uniformly electrodeposited in a subsequent step (electroforming step). The conductive layer 38 is preferably a film composed mainly of Ni. Since such a film composed mainly of Ni can be easily formed and is hard, it is suitable as the conductive film. The thickness of the conductive layer 38 is not particularly limited; generally though, the thickness is several tens of nanometers or so.

Then, as shown in FIG. 4H, a metal plate 40 made of a metal (Ni in this case), which has a desired thickness, is laid over the surface of the original master 36 by electroforming (reversed plate forming step). This step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 (which is a master substrate equivalent to the base material 202 explained with FIG. 2) does not warp.

The original master 36 over which the metal plate 40 has been laid as described above is taken out from the electrolytic solution in the electroforming device and then immersed in purified water placed in a release bath (not shown).

Subsequently, in the release bath, the metal plate 40 is separated from the original master 36 (separating step), and a master substrate 42 having a concavo-convex pattern which is an inversion of the concavo-convex pattern of the original master 36 is thus obtained as shown in FIG. 4I.

Subsequently, as shown in FIG. 4J, a magnetic layer 48 is formed on the concavo-convex surface of the master substrate 42. Examples of the material for the magnetic layer 48 include CoPt. The thickness of the magnetic layer 48 is preferably 5 nm to 200 nm, more preferably 10 nm to 100 nm, and even more preferably 15 nm to 50 nm. The magnetic layer 48 is formed by sputtering, using a target made of the above-mentioned material. Additionally, an underlying layer may be formed before the formation of the magnetic layer 48. The material for this underlying layer is Ta, for example.

Thereafter, the master substrate 42 is subjected to punching such that its inner and outer diameters have predetermined sizes. By the above-mentioned process, a master disk 20 having the concavo-convex pattern provided with the magnetic layer 48 (equivalent to the magnetic layers 204 and 214 in FIGS. 2A and 2B respectively) is produced as shown in FIG. 4J.

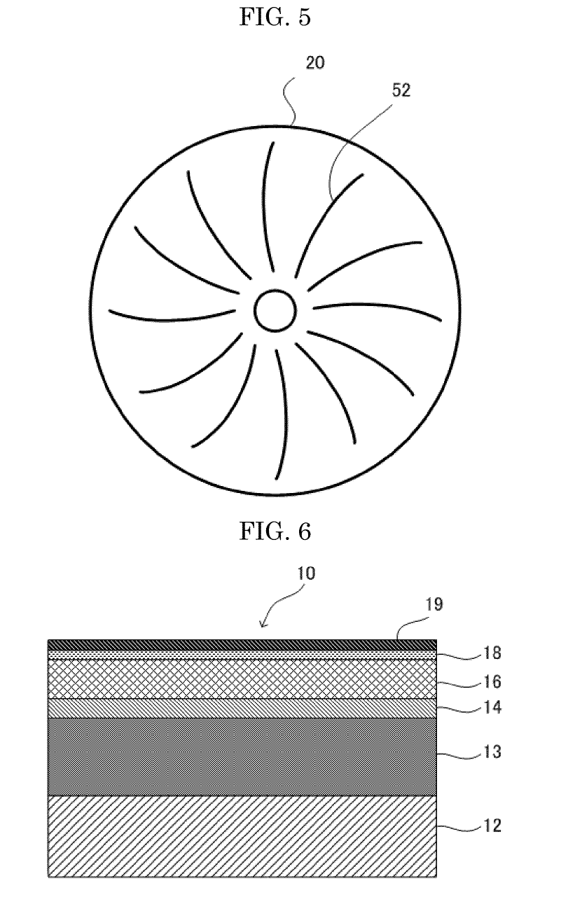

FIG. 5 is a top view of the master disk 20. As shown in FIG. 5, a servo pattern 52 that is a concavo-convex pattern is formed on the surface of the master disk 20. Also, although not shown therein, a protective film (protective layer) made, for example, of diamond-like carbon may be provided over the magnetic layer 48 (see FIG. 4J) on the surface of the master disk 20, and further, a lubricant layer may be provided over the protective film.

The purpose of the provision of the protective layer is to prevent a case in which when the master disk 20 is closely attached to the slave disk 10, the magnetic layer 48 easily gets scratched and the use of the master disk 20 is thus made impossible. The lubricant layer has an effect of preventing, for example, formation of scratches attributed to friction caused when the master disk 20 is brought into contact with the slave disk 10, and thusly improving the durability of the master disk 20.

Specifically, a preferred structure is as follows: a carbon film having a thickness of 2 nm to 30 nm is formed as a protective layer, and a lubricant layer is formed thereon. Also, in order to enhance the adhesion between the magnetic layer 48 and the protective layer, an adhesion enhancing layer of Si or the like may be formed on the magnetic layer 48 before forming the protective layer.

### <Explanation of Slave Disk (Perpendicular Magnetic Recording Medium)>

The slave disk 10 shown in FIGS. 1A to 1C includes a disc-shaped substrate, and magnetic layer(s) formed over one or both surfaces of the substrate. Specific examples thereof include high-density hard disks. The following explains a perpendicular magnetic recording medium with reference to FIG. 6, employing the slave disk 10 as an example.

FIG. 6 is a drawing for explaining a cross section of the slave disk 10. As shown in FIG. 6, the slave disk 10 includes a nonmagnetic substrate 12 made, for example, of glass and also includes a soft magnetic layer (soft magnetic underlying layer: SUL) 13, a nonmagnetic layer (intermediate layer) 14 and a magnetic layer (perpendicular magnetic recording layer) 16 formed over the substrate 12. Further, a protective layer 18 and a lubricant layer 19 are formed over the magnetic layer 16. Note that although an example in which the magnetic layer 16 is formed over one surface of the substrate 12 is herein shown, an aspect in which magnetic layers are formed over both surfaces of the substrate 12 is possible as well.

The disc-shaped substrate 12 is made of a nonmagnetic material such as glass or Al (aluminum). After the soft magnetic layer 13 is formed on the substrate 12, the nonmagnetic layer 14 and the magnetic layer 16 are formed.

The soft magnetic layer 13 is useful in that the perpendicularly magnetized state of the magnetic layer 16 can be stabilized and sensitivity at the times of recording and reproduction can be improved. The material used for the soft magnetic layer 13 is preferably selected from soft magnetic materials, for example CoZrNb, FeTaC, FeZrN, FeSi alloys, FeAl alloys, FeNi alloys such as permalloy, and FeCo alloys such as permendur. This soft magnetic layer 13 is provided with magnetic anisotropy in radius directions (in a radial manner) from the center of the disk toward the outside.

The thickness of the soft magnetic layer 13 is preferably 20 nm to 2,000 nm, more preferably 40 nm to 400 nm.

The nonmagnetic layer 14 is provided in order to increase the magnetic anisotropy of the subsequently formed magnetic layer 16 in a perpendicular direction or for some other reason. The material used for the nonmagnetic layer 14 is preferably selected from Ti (titanium), Cr (chromium), CrTi, CoCr, CrTa, CrMo, NiAl, Ru (ruthenium), Pd (palladium), Ta, Pt and the like. The nonmagnetic layer 14 is formed by depositing the material by means of sputtering. The thickness of the nonmagnetic layer 14 is preferably 10 nm to 150 nm, more preferably 20 nm to 80 nm.

The magnetic layer 16 is formed of a perpendicular magnetization film (which is configured such that magnetization easy axes in a magnetic film are oriented primarily perpendicularly to the substrate), and information is to be recorded in this magnetic layer 16. The material used for the magnetic layer 16 is preferably selected from Co (cobalt), Co alloys (CoPtCr, CoCr, CoPtCrTa, CoPtCrNbTa, CoCrB, CoNi, etc.), Co alloy-SiO₂, Co alloy-TiO₂, Fe, Fe alloys (FeCo, FePt, FeCoNi, etc.) and the like. High in magnetic flux density, any of these materials can have perpendicular magnetic anisotropy by adjustment of a deposition condition and/or its composition. The magnetic layer 16 is formed by depositing the material by means of sputtering. The thickness of the magnetic layer 16 is preferably 10 nm to 500 nm, more preferably 20 nm to 200 nm.

In the present embodiment, a disc-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr); thereafter, Ar (argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUL by sputtering with the use of a Ru target provided in the chamber. Further, a second SUL having a thickness of 80 nm is deposited on the Ru layer by sputtering with the use of a CoZrNb target. With a magnetic field of 50 Oe or higher being applied in radius directions, the temperature of the SULs thus deposited by sputtering is raised to 200° C. and then cooled to room temperature.

Next, sputtering deposition is carried out by means of electric discharge under such a condition that the substrate temperature is made equal to room temperature, with the use of a Ru target. In this manner, the nonmagnetic layer 14 formed of Ru is deposited so as to have a thickness of 60 nm.

Thereafter, in a similar manner, Ar gas is introduced, and sputtering deposition is carried out by means of electric discharge under such a condition that the substrate temperature is made equal to room temperature, with the use of a CoCrPt—SiO₂ target provided in the same chamber. In this manner, the magnetic layer 16 which is formed of CoCrPt—SiO₂ and has a granular structure is deposited so as to have a thickness of 25 nm.

By the above-mentioned process, the transfer magnetic disk (slave disk) 10, in which the soft magnetic layer, the nonmagnetic layer and the magnetic layer have been deposited over the glass substrate, is produced.

### (Magnetic Transfer Method)

A magnetic transfer method of the present invention includes at least an initially magnetizing step, a closely attaching step and a magnetic transfer step, and if necessary includes other step(s).

### <Initially Magnetizing Step>

The initially magnetizing step is a step of initially magnetizing a perpendicular magnetic recording medium in a perpendicular direction. Here, note that the perpendicular direction may involve an angular difference of within ±10°, preferably within ±5°, from the vertical direction to the surface of the perpendicular magnetic recording medium.

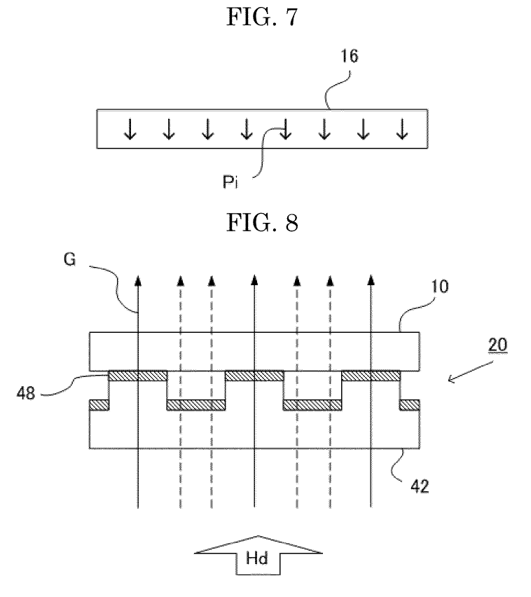

For instance, as shown in FIG. 1A, initial magnetization of the slave disk 10 is performed by generation of an initializing magnetic field Hi with the use of a device (magnetic field applying unit (not shown)) capable of applying a DC magnetic field perpendicularly to the surface of the slave disk 10. Specifically, it is performed by generating as the initializing magnetic field Hi a magnetic field which is greater than or equal to the coercive force Hc of the slave disk 10 in strength. By this initially magnetizing step, the magnetic layer 16 of the slave disk 10 is subjected to an initial magnetization Pi in one direction perpendicular to the disk surface, as shown in FIG. 7. It should be noted that this initially magnetizing step may be carried out by rotating the slave disk 10 relatively to the magnetic field applying unit.

### <Closely Attaching Step>

The closely attaching step is a step of closely attaching a magnetic transfer master carrier to the initially magnetized perpendicular magnetic recording medium. For instance, a step (closely attaching step) is carried out in which, as shown in FIG. 1B, the master disk 20 and the initially magnetized slave disk 10 are laid one on top of the other and closely attached to each other. In the closely attaching step, as shown in FIG. 1B, the surface of the master disk 20 on the side of the protrusion pattern (concavo-convex pattern) and the surface of the slave disk 10 on the side of the magnetic layer 16 are closely attached to each other with a predetermined pressing force.

Before closely attached to the master disk 20, the slave disk 10 is, if necessary, subjected to a cleaning process (burnishing or the like) in which minute protrusions or attached dust on its surface is removed using a glide head, a polisher, etc.

As to the closely attaching step, there is a case in which the master disk 20 is closely attached to only one surface of the slave disk 10 as shown in FIG. 1B, and there is another case in which master disks are closely attached to both surfaces of a transfer magnetic disk, where magnetic layers have been formed. The latter case is advantageous in that transfer to both the surfaces can be simultaneously performed.

### <Magnetic Transfer Step>

The magnetic transfer step is a step of transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other.

Note that the opposite direction to the direction of the initial magnetization does not necessarily mean the completely opposite direction to the direction of the initial magnetization but may involve an angular difference of within ±10° from the completely opposite direction.

Here, the magnetic transfer step is explained with reference to FIG. 1C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is effected by entry of a magnetic flux, produced by generating the recording magnetic field Hd, into the slave disk 10 and the master disk 20.

In the present embodiment, the value of the recording magnetic field Hd is approximately equal to that of the coercive force Hc of the magnetic material constituting the magnetic layer 16 of the slave disk 10.

In the magnetic transfer, while the slave disk 10 and the master disk 20 closely attached to each other are being rotated by a rotating unit (not shown), the recording magnetic field Hd is applied by the magnetic field applying unit, and information in the form of the protrusion pattern, recorded on the master disk 20, is magnetically transferred to the magnetic layer 16 of the slave disk 10. Apart from this structure, a mechanism for rotating the magnetic field applying unit may be provided such that the magnetic field applying unit is rotated relatively to the slave disk 10 and the master disk 20.

FIG. 8 shows a cross section of the slave disk 10 and the master disk 20 in the magnetic transfer step. When the recording magnetic field Hd is applied with the slave disk 10 closely attached to the master disk 20 having the concavo-convex pattern as shown in FIG. 8, a magnetic flux G becomes strong in areas where the convex portions of the master disk 20 and the slave disk 10 are in contact with each other, the recording magnetic field Hd causes the magnetization direction of the magnetic layer 48 of the master disk 20 to align with the direction of the recording magnetic field Hd, and thus the magnetic information is transferred to the magnetic layer 16 of the slave disk 10. Meanwhile, at the concave portions of the master disk 20, the magnetic flux G generated by the application of the recording magnetic field Hd is weaker than at the convex portions, and the magnetization direction of portions of the magnetic layer 16 of the slave disk 10 which correspond to the concave portions does not change, so that the portions remain in the initially magnetized state.

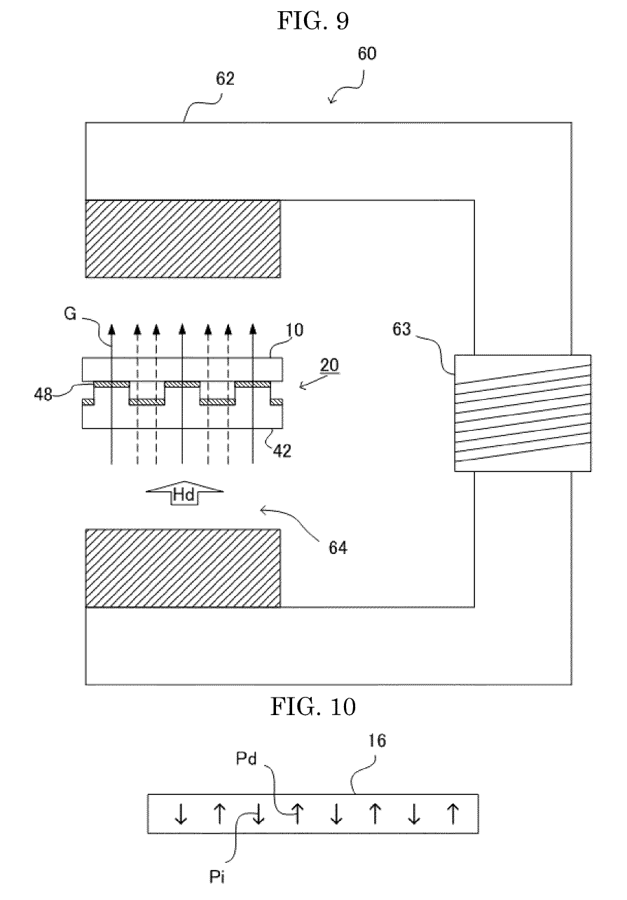

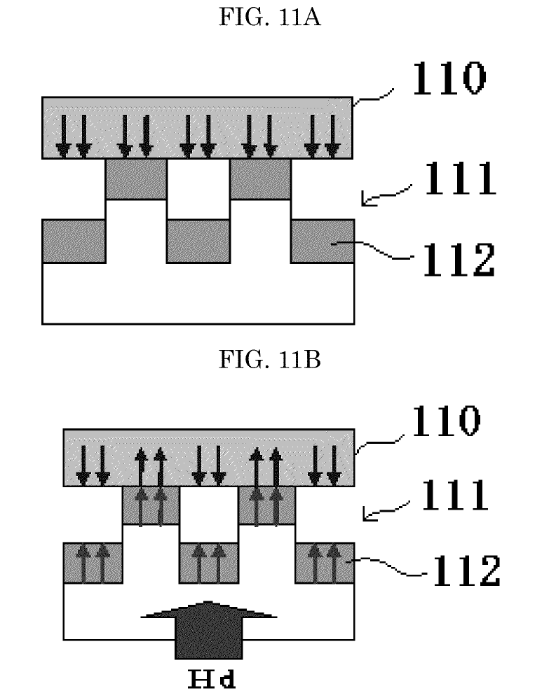

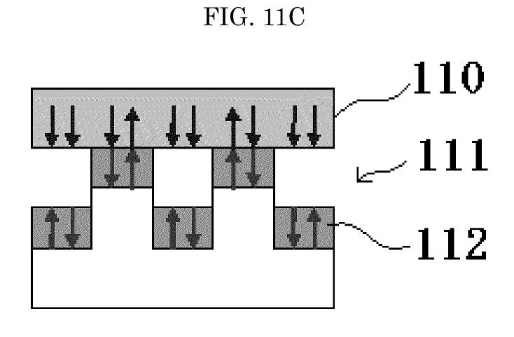

FIG. 9 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10 in a closely attached state. The direction of the magnetic field generated can be changed depending upon the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using this magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is effected by applying as the recording magnetic field Hd a magnetic field which is equivalent in strength to 60% to 130%, preferably 70% to 120%, of the coercive force Hc of the magnetic layer 16 of the slave disk 10 used in the present embodiment.

Thus, in the magnetic layer 16 of the slave disk 10, information in the form of a magnetic pattern, such as a servo signal, is recorded as a recording magnetization Pd which acts in the opposite direction to the direction of the initial magnetization Pi (see FIG. 10).

### <Other Step(s)>

The other step(s) is/are not particularly limited and may be suitably selected according to the purpose.

In carrying out the present invention, the protrusion pattern formed on the master disk 20 may be a negative pattern, as opposed to the positive pattern explained with FIG. 4J. In this case, a similar magnetization pattern can be magnetically transferred to the magnetic layer 16 of the slave disk 10 by reversing the direction of the initializing magnetic field Hi and the direction of the recording magnetic field Hd. Also, although a case where the magnetic field applying unit is an electromagnet has been explained in the present embodiment, a permanent magnet which similarly generates a magnetic field may be used as well.

A perpendicular magnetic recording medium produced by the method according to the above-mentioned embodiment of the present invention will be used, installed in a magnetic recording and reproducing device such as a hard disk device, for example. This makes it possible to obtain a high-recording-density magnetic recording and reproducing device with high servo precision and excellent recording and reproducing properties.

### EXAMPLES

The following explains Examples of the present invention. It should, however, be noted that the present invention is not confined to these Examples in any way.

### Example 1

### Production of Master Carrier

An electron beam resist was applied onto an 8 inch Si (silicon) wafer (substrate) by spin coating so as to have a thickness of 100 nm. After the application, the resist on the substrate was exposed using a rotary electron beam exposure apparatus, then the exposed resist was developed, and a resist Si substrate having a concavo-convex pattern was thus produced.

Thereafter, the substrate was subjected to reactive ion etching, with the resist used as a mask, such that concave portions of the concavo-convex pattern enlarged downward. After this etching, the resist remaining on the substrate was removed by washing with a solvent capable of dissolving the resist. After the removal, the substrate was dried, and the dried substrate was used as an original master for producing a master carrier.

### <Production of Master Carrier Intermediate Member by Plating>

A Ni (nickel) conductive film was formed on the original master by sputtering so as to have a thickness of 20 nm. The original master on which the conductive film had been formed was immersed in a nickel sulfamate bath, and a Ni film having a thickness of 200 μm was formed by electrolytic plating. Thereafter, the Ni film was separated from the original master, which was followed by washing, and a Ni master carrier intermediate member was thus obtained.

### <Method of Forming Magnetic Layer for Magnetic Transfer>

The Ni master carrier intermediate member was set in a given chamber and subjected to sputtering under such conditions that the deposition pressure (pressure of Ar gas) was 0.3 Pa, the distance between the Ni master carrier intermediate member and a target was 200 mm and the electric power was 1,000 W DC, so as to form a Ta underlying layer (10 nm in thickness) on edge surfaces of convex portions of the Ni master carrier intermediate member. After the formation of the Ta underlying layer, a magnetic layer that was a CoPt film (Co: 92 at. %, Pt: 8 at. %) was formed so as to have a thickness of 40 nm under such conditions that the deposition pressure (pressure of Ar gas) was 0.3 Pa, the distance between the Ni master carrier intermediate member and a target was 200 mm and the electric power was 1,000 W DC, and a master carrier was thus obtained. The magnetic layer of this master carrier had a magnetic anisotropy energy of 1.2×10⁶ erg/cm³ and a saturation magnetization of 1,280 emu/cc. How the magnetic anisotropy energy and the saturation magnetization were measured will be later described.

A concavo-convex pattern was formed on the master carrier produced in Example 1, such that the line width of a magnetic signal transferred to a perpendicular magnetic recording medium had a predetermined value (e.g. 100 nm).

Specifically, the master carrier produced had the following concavo-convex pattern.

A linear pattern in which lines gradually increased in width from the inner circumferential side toward the outer circumferential side of the disc-shaped master carrier was disposed such that the period length of the concavo-convex pattern was twice as large as the intended signal line width. At that time, the signal line width on the innermost circumferential side was adjusted to 50 nm, the signal line width on the intermediate circumferential side was adjusted to 100 nm, and the signal line width on the outermost circumferential side was adjusted to 150 nm. As for the number of lines in the linear pattern, 150 sectors (1 sector=100 lines) were disposed at regular intervals with respect to the circumferential direction.

### <Production of Perpendicular Magnetic Recording Medium>

A soft magnetic layer, a first nonmagnetic orientation layer, a second nonmagnetic orientation layer, a magnetic recording layer and a protective layer were formed, in this order, over a 2.5 inch glass substrate by sputtering. Further, a lubricant layer was formed on the protective layer by dipping.

CoZrNb was used as the material for the soft magnetic layer. The soft magnetic layer had a thickness of 100 nm. The glass substrate was placed facing the CoZrNb target, then Ar gas was introduced such that the pressure stood at 0.6 Pa, and the soft magnetic layer was deposited at 1,500 W DC.

A 5 nm layer of Ti was formed as the first nonmagnetic orientation layer, and a 6 nm layer of Ru was formed as the second nonmagnetic orientation layer.

Specifically, the glass substrate and the soft magnetic layer were placed facing a Ti target, then Ar gas was introduced such that the pressure stood at 0.5 Pa, electric discharge was performed at 1,000 W DC, and a Ti seed layer was deposited as the first nonmagnetic orientation layer so as to have a thickness of 5 nm. Afterward, the glass substrate, the soft magnetic layer and the first nonmagnetic orientation layer were placed facing a Ru target, then Ar gas was introduced such that the pressure stood at 0.8 Pa, electric discharge was performed at 900 W DC, and the second nonmagnetic orientation layer was deposited so as to have a thickness of 6 nm.

A 18 nm layer of CoCrPtO was formed as the magnetic recording layer. Specifically, the glass substrate, the soft magnetic layer, the first nonmagnetic orientation layer and the second nonmagnetic orientation layer were placed facing a CoCrPtO target, then Ar gas containing 0.06% of O₂ was introduced such that the pressure stood at 14 Pa, electric discharge was performed at 290 W DC, and the magnetic recording layer was formed so as to have a thickness of 18 nm.

Afterward, the glass substrate and the above-mentioned layers were placed facing a C (carbon) target, then Ar gas was introduced such that the pressure stood at 0.5 Pa, electric discharge was performed at 1,000 W DC, and a carbon protective layer was formed so as to have a thickness of 4 nm. The coercive force of this recording medium was adjusted to 334 kA/m (4.2 kOe).

Further, a PFPE lubricant was applied over the medium by dipping so as to have a thickness of 2 nm.

As described above, a perpendicular magnetic recording medium was produced.

### <Initially Magnetizing Step>

The perpendicular magnetic recording medium was initially magnetized. The strength of a magnetic field applied at the time of the initial magnetization (initial magnetic field strength) was 10 kOe.

### <Closely Attaching Step and Magnetic Transfer Step>

The master carrier was placed facing the initially magnetized perpendicular magnetic recording medium, and these were closely attached to each other at a pressure of 0.7 MPa. With these closely attached to each other, a magnetic field was applied so as to effect magnetic transfer. The strength of the magnetic field used for the magnetic transfer was 4.6 kOe. After the magnetic field had finished being applied, the master carrier was separated from the perpendicular magnetic recording medium.

### <Evaluation>

The following evaluations were carried out.

In Example 1, evaluations of signal qualities (signal output and output variation) were carried out on a portion of the perpendicular magnetic recording medium where the line width of a transferred magnetic signal was 100 nm.

The line width of the magnetic signal transferred to the perpendicular magnetic recording medium was calculated from an image of the magnetic signal measured using a magnetic force microscope (NANOSCOPE IV, manufactured by Nihon Veeco K.K.).

### <<Measurement of Magnetic Anisotropy Energy of Magnetic Layer>>

An underlying layer and a magnetic layer which were the same as the underlying layer and the magnetic layer of the master carrier of Example 1 were formed as a sample over a 2.5 inch glass substrate under the same conditions as in Example 1. The sample formed over the glass substrate was cut into a size of 6 mm×8 mm, and the magnetic anisotropy energy of the cut sample was measured using a magnetic anisotropy torquemeter (TRT-2, manufactured by TOEI INDUSTRY CO., LTD.).

### <<Measurement of Saturation Magnetization of Magnetic Layer>>

A magnetization curve of the sample whose magnetic anisotropy energy had been measured was produced using a vibrating sample magnetometer (VSM-C7, manufactured by TOEI INDUSTRY CO., LTD.). The saturation magnetic moment (emu) was calculated from the magnetization curve.

Further, using the sample, the thicknesses of the underlying layer and the magnetic layer were measured with an atomic force microscope (Dimension 5000, manufactured by Nihon Veeco K.K.).

The saturation magnetic moment was divided by the volume of the magnetic layer (sample) so as to obtain the saturation magnetization per volume (emu/cc).

### <<Measurement of Thickness of Magnetic Layer>>

The thickness of the magnetic layer of the master carrier was measured with an atomic force microscope (Dimension 5000, manufactured by Nihon Veeco K.K.).

### <<Servo Signal Qualities>>

### <<<Signal Output>>>

The reproduction output of the signal recorded onto the perpendicular magnetic recording medium which had undergone the magnetic transfer, using the linear pattern of the master carrier, was detected in all sectors. For the detection, an evaluating device (LS-90, manufactured by Kyodo electronics inc.) with a GMR head having a read width of 100 nm was used. The reproduction output was measured in radius positions where the signal line width was 100 nm; subsequently, the overall average value S/N (PS/N) concerning 150 sectors was calculated. Also, the reproduction output was measured in radius positions where the signal line width was 150 nm; subsequently, S/N (HS/N) for reference was calculated. The ratio (PS/N)/(HS/N) was calculated and the signal output was judged as follows: when the ratio was 80% or more in percentage terms, the signal output was judged to be “excellent”; when the ratio was 60% or more but less than 80% in percentage terms, the signal output was judged to be “favorable”; when the ratio was 40% or more but less than 60% in percentage terms, the signal output was judged to be “somewhat inferior”; and when the ratio was less than 40% in percentage terms, the signal output was judged to be “inferior”.

### <<<Variation in Output on Convex Portion Side>>>

The variation in output on the convex portion side was evaluated as follows.

Here, the term “output on the convex portion side” means the strength (zero is the reference value) of a signal on the perpendicular magnetic recording medium, magnetically reversed by the magnetic transfer so as to act in the opposite direction to the direction in the initially magnetized state. The standard deviation (σ) of output was calculated from reproduction outputs regarding 150 sectors, measured in radius positions where the signal line width was 100 nm, and the variation was judged as follows: when the value of the standard deviation was less than 10% in percentage terms, the variation was judged to be “excellent”; when the value of the standard deviation was 10% or more but less than 20% in percentage terms, the variation was judged to be “favorable”; when the value of the standard deviation was 20% or more but less than 30% in percentage terms, the variation was judged to be “somewhat inferior”; and when the value of the standard deviation was 30% or more in percentage terms, the variation was judged to be “inferior”.

### <<<Variation in Output on Concave Portion Side>>>

The variation in output on the concave portion side was evaluated as follows.

Here, the term “output on the concave portion side” means the strength (zero is the reference value) of a signal on the perpendicular magnetic recording medium, that remained acting in the same direction as in the initially magnetized state after the magnetic transfer. The standard deviation (σ) of output was calculated from reproduction outputs regarding 150 sectors, measured in radius positions where the signal line width was 100 nm, and the variation was judged as follows: when the value of the standard deviation was less than 10% in percentage terms, the variation was judged to be “excellent”; when the value of the standard deviation was 10% or more but less than 20% in percentage terms, the variation was judged to be “favorable”; when the value of the standard deviation was 20% or more but less than 30% in percentage terms, the variation was judged to be “somewhat inferior”; and when the value of the standard deviation was 30% or more in percentage terms, the variation was judged to be “inferior”.

### Example 2

A master carrier was produced in the same manner as in Example 1, except that a CoCr film (Co: 90 at. %, Cr: 10 at. %) was formed as a magnetic layer instead of the CoPt film (Co: 92 at. %, Pt: 8 at. %). The magnetic layer of this master carrier had a magnetic anisotropy energy of 3.4×10⁶ erg/cm³ and a saturation magnetization of 1,090 emu/cc.

### Example 3

A master carrier was produced in the same manner as in Example 2, except that a CoCr film (Co: 90 at. %, Cr: 10 at. %) having a thickness of 50 nm was formed as a magnetic layer instead of the CoCr film (Co: 90 at. %, Cr: 10 at. %) having a thickness of 40 nm. The magnetic layer of this master carrier had a magnetic anisotropy energy of 3.4×10⁶ erg/cm³ and a saturation magnetization of 1,090 emu/cc.

### Example 4

A master carrier was produced in the same manner as in Example 2, except that a CoCr film (Co: 90 at. %, Cr: 10 at. %) having a thickness of 60 nm was formed as a magnetic layer instead of the CoCr film (Co: 90 at. %, Cr: 10 at. %) having a thickness of 40 nm. The magnetic layer of this master carrier had a magnetic anisotropy energy of 3.4×10⁶ erg/cm³ and a saturation magnetization of 1,090 emu/cc.

### Example 5

A master carrier was produced in the same manner as in Example 1, except that a CoCr film (Co: 85 at. %, Cr: 15 at. %) was formed as a magnetic layer instead of the CoPt film (Co: 92 at. %, Pt: 8 at. %). The magnetic layer of this master carrier had a magnetic anisotropy energy of 2.5×10⁶ erg/cm³ and a saturation magnetization of 860 emu/cc.

### Example 6

A master carrier was produced in the same manner as in Example 5, except that the deposition pressure for the Ta underlying layer and the deposition pressure for the CoCr film (Co: 85 at. %, Cr: 15 at. %) were both changed from 0.3 Pa to 7.0 Pa. The magnetic layer of this master carrier had a magnetic anisotropy energy of 1.8×10⁶ erg/cm³ and a saturation magnetization of 570 emu/cc.

### Example 7

A master carrier was produced in the same manner as in Example 1, except that a FeCo film (Fe: 50 at. %, Cr: 50 at. %) was formed as a magnetic layer instead of the CoPt film (Co: 92 at. %, Pt: 8 at. %). The magnetic layer of this master carrier had a magnetic anisotropy energy of 4.0×10⁵ erg/cm³ and a saturation magnetization of 1,600 emu/cc.

### Example 8

A master carrier was produced in the same manner as in Example 1, except that a Co film was formed as a magnetic layer instead of the CoPt film (Co: 92 at. %, Pt: 8 at. %). The magnetic layer of this master carrier had a magnetic anisotropy energy of 8.0×10⁵ erg/cm³ and a saturation magnetization of 1,390 emu/cc.

### Example 9

A master carrier was produced in the same manner as in Example 1, except that a CoPt film (Co: 90 at. %, Pt: 10 at. %) was formed as a magnetic layer instead of the CoPt film (Co: 92 at. %, Pt: 8 at. %). The magnetic layer of this master carrier had a magnetic anisotropy energy of 2.8×10⁶ erg/cm³ and a saturation magnetization of 1,250 emu/cc.

### Example 10

A master carrier was produced in the same manner as in Example 1, except that a CoPt film (Co: 92 at. %, Pt: 8 at. %) having a thickness of 10 nm was formed as a magnetic layer instead of the CoPt film (Co: 92 at. %, Pt: 8 at. %) having a thickness of 40 nm. The magnetic layer of this master carrier had a magnetic anisotropy energy of 1.2×10⁶ erg/cm³ and a saturation magnetization of 1,280 emu/cc.

### Example 11

A master carrier was produced in the same manner as in Example 1, except that a CoPt film (Co: 92 at. %, Pt: 8 at. %) having a thickness of 15 nm was formed as a magnetic layer instead of the CoPt film (Co: 92 at. %, Pt: 8 at. %) having a thickness of 40 nm. The magnetic layer of this master carrier had a magnetic anisotropy energy of 1.2×10⁶ erg/cm³ and a saturation magnetization of 1,280 emu/cc.

### Example 12

A master carrier was produced in the same manner as in Example 1, except that a CoPt film (Co: 92 at. %, Pt: 8 at. %) having a thickness of 20 nm was formed as a magnetic layer instead of the CoPt film (Co: 92 at. %, Pt: 8 at. %) having a thickness of 40 nm. The magnetic layer of this master carrier had a magnetic anisotropy energy of 1.2×10⁶ erg/cm³ and a saturation magnetization of 1,280 emu/cc.

### Example 13

A master carrier was produced in the same manner as in Example 1, except that a CoPt film (Co: 92 at. %, Pt: 8 at. %) having a thickness of 30 nm was formed as a magnetic layer instead of the CoPt film (Co: 92 at. %, Pt: 8 at. %) having a thickness of 40 nm. The magnetic layer of this master carrier had a magnetic anisotropy energy of 1.2×10⁶ erg/cm³ and a saturation magnetization of 1,280 emu/cc.

### Comparative Example 1

A master carrier was produced in the same manner as in Example 1, except that a CoPt film (Co: 88 at. %, Pt: 12 at. %) was formed as a magnetic layer instead of the CoPt film (Co: 92 at. %, Pt: 8 at. %). The magnetic layer of this master carrier had a magnetic anisotropy energy of 5.2×10⁶ erg/cm³ and a saturation magnetization of 1,260 emu/cc.

### Comparative Example 2

A master carrier was produced in the same manner as in Example 1, except that a CoPt film (Co: 70 at. %, Pt: 30 at. %) was formed as a magnetic layer instead of the CoPt film (Co: 92 at. %, Pt: 8 at. %). The magnetic layer of this master carrier had a magnetic anisotropy energy of 1.4×10⁷ erg/cm³ and a saturation magnetization of 1,190 emu/cc.

The master carriers of Examples 2 to 13 and Comparative Examples 1 and 2, and magnetic recording media to which magnetic information had been transferred using these master carriers were evaluated in the above-mentioned manner explained with Example 1. The results are shown in Table 1.

TABLE 1

| | | | | | | Variation in | | Variation in | | |
|---|---|---|---|---|---|---|---|---|---|---|
| | Magnetic | | | | | output on | | output on | | |
| Signal | anisotropy | Saturation | Film | Signal | | convex | | concave | | |
| amplitude: | energy | magnetization | thickness | output | | portion side | | portion side | | Overall |
| 100 nm | Ku (erg/cm³) | Ms (emu/cc) | (μm) | (%) | Evaluation | (%) | Evaluation | (%) | Evaluation | evaluation |
| Ex 7 | 4.0 × 10⁵ | 1,600 | 40 | 61 | B | 18.5 | B | 19.8 | B | B |
| Ex 8 | 8.0 × 10⁵ | 1,390 | 40 | 74 | B | 16.3 | B | 19.4 | B | B |
| Ex 1 | 1.2 × 10⁶ | 1,280 | 40 | 92 | A | 8.6 | A | 9.2 | A | A |
| Ex 9 | 2.8 × 10⁶ | 1,250 | 40 | 90 | A | 11.4 | B | 9.5 | A | B |
| Ex 2 | 3.4 × 10⁶ | 1,090 | 40 | 86 | A | 14.6 | B | 8.6 | A | B |
| Comp Ex 1 | 5.2 × 10⁶ | 1,260 | 40 | 90 | A | 30.4 | D | 9.6 | A | D |
| Comp Ex 2 | 1.4 × 10⁷ | 1,190 | 40 | 89 | A | 32.5 | D | 9.4 | A | D |
| Ex 10 | 1.2 × 10⁶ | 1,280 | 10 | 64 | B | 13.7 | B | 17.3 | B | B |
| Ex 11 | 1.2 × 10⁶ | 1,280 | 15 | 77 | B | 9.0 | A | 12.9 | B | B |
| Ex 12 | 1.2 × 10⁶ | 1,280 | 20 | 94 | A | 7.9 | A | 7.8 | A | A |
| Ex 13 | 1.2 × 10⁶ | 1,280 | 30 | 92 | A | 8.0 | A | 8.6 | A | A |
| Ex 3 | 3.4 × 10⁶ | 1,090 | 50 | 88 | A | 21.3 | C | 7.9 | A | B |
| Ex 4 | 3.4 × 10⁶ | 1,090 | 60 | 89 | A | 25.7 | C | 7.5 | A | B |
| Ex 5 | 2.5 × 10⁶ | 860 | 40 | 72 | B | 9.2 | A | 10.8 | B | B |
| Ex 6 | 1.8 × 10⁶ | 570 | 40 | 55 | C | 9.4 | A | 11.7 | B | B |

It was confirmed that perpendicular magnetic recording media to which magnetic information had been transferred using the master carriers of Examples were superior to those to which magnetic information had been transferred using the master carriers of Comparative Examples in terms of the results concerning “variation in output on convex portion side”. This indicates that the decrease in the magnetic anisotropy energy of the magnetic layer on convex portions of the master carrier of each Example resulted in a decrease in the remanent magnetization of the magnetic layer, and thus transfer signals were less disturbed.

What is claimed is:

1. A magnetic transfer master carrier to be placed on a perpendicular magnetic recording medium so as to transfer magnetic information to the medium by application of a magnetic field, the magnetic transfer master carrier comprising:
transfer portions that include a magnetic layer and correspond to the magnetic information; and
non-transfer portions which are lower in height than the transfer portions that include the magnetic layer, and each of which has a concave shape,
wherein the magnetic layer has perpendicular magnetic anisotropy, and the magnetic anisotropy energy of the magnetic layer is less than 4×10⁶ erg/cm³.

2. The magnetic transfer master carrier according to claim 1, wherein the magnetic anisotropy energy of the magnetic layer is in the range of 6×10⁵ erg/cm³ to 3×10⁶ erg/cm³.

3. The magnetic transfer master carrier according to claim 2, wherein the magnetic anisotropy energy of the magnetic layer is in the range of 9×10⁵ erg/cm³ to 2×10⁶ erg/cm³.

4. The magnetic transfer master carrier according to claim 1, wherein the magnetic layer has a thickness of less than 50 nm.

5. The magnetic transfer master carrier according to claim 4, wherein the magnetic layer has a thickness of 10 nm to 40 nm.

6. The magnetic transfer master carrier according to claim 5, wherein the magnetic layer has a thickness of 20 nm to 40 nm.

7. The magnetic transfer master carrier according to claim 1, wherein the magnetic layer has a saturation magnetization (Ms) of 600 emu/cc or above.

8. A magnetic transfer method comprising:
initially magnetizing a perpendicular magnetic recording medium in a perpendicular direction;
closely attaching a magnetic transfer master carrier to the initially magnetized perpendicular magnetic recording medium; and
transferring magnetic information to the perpendicular magnetic recording medium by applying a perpendicular magnetic field which acts in the opposite direction to the direction of the initial magnetization, with the perpendicular magnetic recording medium and the magnetic transfer master carrier closely attached to each other,
wherein the magnetic transfer master carrier is placed on the perpendicular magnetic recording medium so as to transfer the magnetic information to the medium by application of the magnetic field, the magnetic transfer master carrier comprising transfer portions that include a magnetic layer and correspond to the magnetic information, and non-transfer portions which are lower in height than the transfer portions that include the magnetic layer, and each of which has a concave shape, and
wherein the magnetic layer has perpendicular magnetic anisotropy, and the magnetic anisotropy energy of the magnetic layer is less than 4×10⁶ erg/cm³.
